(19) United States
(12) Patent Application Publication
(10) Pub. No.: US 2013/0074315 A1
(43) Pub. Date: Mar. 28, 2013

(54) FASTENER WRENCHING APPARATUS AND METHOD

(71) Applicants: Jonathan C. Slocum, Lagrangeville, NY (US); Robert W. Karol, Easton, PA (US)

(72) Inventors: Jonathan C. Slocum, Lagrangeville, NY (US); Robert W. Karol, Easton, PA (US)

(73) Assignee: ACTUANT CORPORATION, Milwaukee, WI (US)

(21) Appl. No.: 13/702,090

(22) PCT Filed: Jul. 1, 2011
(86) PCT No.: PCT/US11/42769

§ 371 Date: Dec. 5, 2012

Related U.S. Application Data
(60) Provisional application No. 61/362,105, filed on Jul. 7, 2010.

(51) Int. Cl. B25B 13/46

(52) U.S. Cl. CPC B25B 13/46
USPC 29/525.01; 81/58

(57) ABSTRACT

A fastener wrenching apparatus for applying a torque to a fastener includes a reaction support having a head and a foot opposite the head. The foot engages a distal end of the fastener such that the distal end of the fastener is rotatably fixed thereto. A torquing device is supported by the reaction support. The torquing device includes a housing and an output rotatably supported by the housing. The output is disposed proximate the head of the reaction support and rotatably fixedly connects to a proximal end of the fastener. The output rotates the proximal end of the fastener relative to the reaction support and the distal end of the fastener to apply the torque to the fastener. A lock mechanism releasably fixes the reaction support and the torquing device relative to one another.

### CROSS-REFERENCE TO RELATED APPLICATION

This application claims the benefit of U.S. Provisional Patent Application No. 61/362,105 filed Jul. 7, 2010, the disclosure of which is hereby incorporated by reference in its entirety.

### STATEMENT CONCERNING FEDERALLY SPONSORED RESEARCH OR DEVELOPMENT

Not applicable.

### FIELD OF THE INVENTION

This invention relates to torque wrenches and supports for reacting against torque applied to a flange fastener.

### BACKGROUND OF THE INVENTION

Torque wrenches (e.g., hydraulic wrenches, pneumatic wrenches, electric wrenches, and the like) are often used in situations where human operators cannot apply loads to sufficiently torque a fastener, such as tightening bolts that join large adjacent pipe sections at a flange. By applying a torque to the fastener, a torque is also applied to the body of the wrench and, as such, the wrench needs to abut another object to avoid simply rotating itself when it is energized. In some designs, this is achieved using a “reaction arm” that extends from the wrench and contacts an adjacent fastener.

Despite reducing the amount of physical exertion required by human operators, the above-described designs can still provide labor-intensive operations. For example, in some cases an operator must first rotate the wrench to align features of the wrench with features of the fasteners, such as internal hexagonal surfaces of the wrench and external hexagonal surfaces of a nut. In these cases, the reaction arm does not initially contact an adjacent fastener, and the operator must hold the wrench during the initial moments of a tightening process to ensure the wrench does not disengage the fastener.

Furthermore, wrenches typically include an output drive that connects to an actuator through a ratchet mechanism. Such a structure permits the output drive to rotate when the actuator extends, and thereby torque a fastener, but remain stationary when the actuator retracts. Unfortunately, forces applied by springs within the ratchet mechanism cause the wrench to rotate when the actuator begins to retract. This causes the reaction arm to disengage an adjacent fastener and, as such, an operator must typically hold the wrench during operation to ensure it does not also disengage the fastener it is tightening.

Considering the drawbacks of previous wrench designs, improved fastener wrenching devices and methods that do not require a great amount of operator intervention are needed.

### SUMMARY OF THE INVENTION

In one aspect, the present invention provides a fastener wrenching apparatus for applying a torque to a fastener having a proximal end and a distal end. The apparatus comprises a reaction support having a head and a foot opposite the head. The foot engages the distal end of the fastener such that the distal end of the fastener and the foot are engaged so as not to rotate relative to each other. A torquing device is supported by the reaction support. The torquing device includes a housing and an output rotatably supported by the housing. The output is disposed proximate the head of the reaction support and rotatably fixedly connects to the proximal end of the fastener. The output rotates the proximal end of the fastener relative to the reaction support and the distal end of the fastener to apply the torque to the fastener. A lock mechanism releasably fixes the reaction support and the torquing device relative to one another.

In another aspect, the present invention provides a fastener wrenching apparatus for applying a torque to a fastener having a proximal end and a distal end. The apparatus comprises a reaction support that includes a lower support having a foot. The foot defines a foot opening configured to accommodate and thereby engage the distal end of the fastener such that the distal end of the fastener is rotatably fixed to the lower support. The reaction support further includes an upper support that is translatably supported by the lower support. The upper support includes a reaction surface and a head. The apparatus further comprises a torquing device supported by the reaction support proximate the head. The torquing device includes a housing and an output rotatably supported by the housing. The output is configured to connect to the proximal end of the fastener, and the output rotates the proximal end of the fastener relative to the reaction support and the distal end to apply the torque to the fastener. The torquing device further includes a reaction surface defined by the housing. The reaction surface of the torquing device abuts the reaction surface of the reaction support when the output rotates relative to the housing to react against the torque applied to the fastener.

In yet another aspect, the present invention provides a method of applying a torque to a fastener using a fastener wrenching apparatus. The method comprises the steps of: positioning the fastener in an opening of a joint formed at an interface of two separate components such that a proximal end of the fastener is disposed on a proximal side of the joint and a distal end of the fastener is disposed on a distal side opposite the proximal side; connecting the fastener wrenching apparatus to the fastener such that a reaction support of the fastener wrenching apparatus rotatably fixedly engages the distal end of the fastener, and such that a socket rotatably mounted to the reaction support rotatably fixedly engages the proximal end of the fastener; and rotating the socket and the proximal end of the fastener relative to the distal end to thereby apply the torque to the fastener.

The foregoing and objects and advantages of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a top perspective view of a fastener wrenching apparatus according to the present invention connected to a flange between two pipe sections;

FIG. 2 is a bottom perspective view of the fastener wrenching apparatus of FIG. 1;

FIG. 3 is a partial longitudinal section view of the fastener wrenching apparatus along line 3-3 of FIG. 1;

FIG. 4 is a perspective view of a torque wrench of the fastener wrenching apparatus of FIG. 1;

FIG. 5 is a top perspective view of a reaction support and a socket of the fastener wrenching apparatus of FIG. 1;

FIG. 6 is a bottom perspective view of the reaction support and the socket of FIG. 5;

FIG. 7 is a rear exploded perspective view of the reaction support and the socket of FIG. 5;

FIG. 8 is a front exploded perspective view of the reaction support and the socket of FIG. 5;

FIG. 9 is a schematic of torques about the longitudinal axis of a fastener during operation of the fastener wrenching apparatus

FIG. 10 is a top perspective view of a second embodiment of a fastener wrenching apparatus according to the present invention connected to a flange between two pipe sections;

FIG. 11 is a top perspective view of the second embodiment of the fastener wrenching apparatus of FIG. 10;

FIG. 12 is a top perspective partially exploded view of the second embodiment of the fastener wrenching apparatus of FIG. 10;

FIG. 13 is a side perspective partially exploded view of the second embodiment of the fastener wrenching apparatus of FIG. 10;

FIG. 14 is a top perspective view of a third embodiment of a fastener wrenching apparatus according to the present invention connected to a flange between two pipe sections;

FIG. 15 is a top perspective partially exploded view of the third embodiment of the fastener wrenching apparatus of FIG. 14;

FIG. 16 is a bottom perspective view of the third embodiment of the fastener wrenching apparatus of FIG. 14;

FIG. 17 is a side perspective sectional view of a reaction support of the third embodiment of the fastener wrenching apparatus of FIG. 14; and

FIG. 18 is a top perspective view of the third embodiment of the fastener wrenching apparatus of FIG. 14 with a torque wrench configured to loosen a fastener.

### DETAILED DESCRIPTION OF THE PREFERRED EMBODIMENT

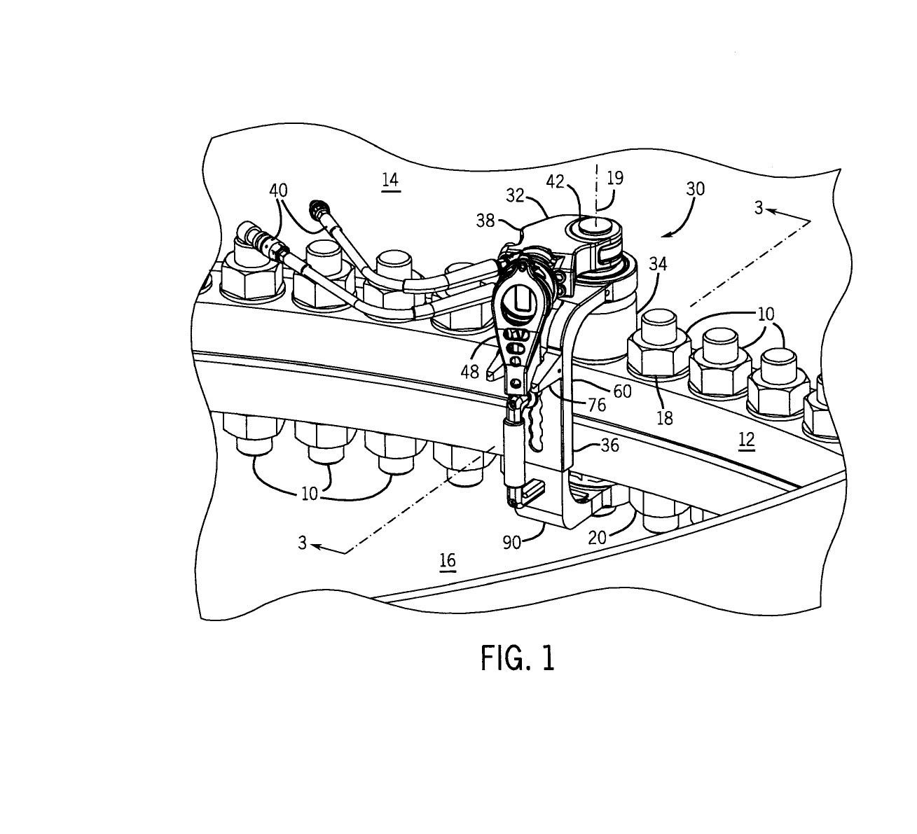

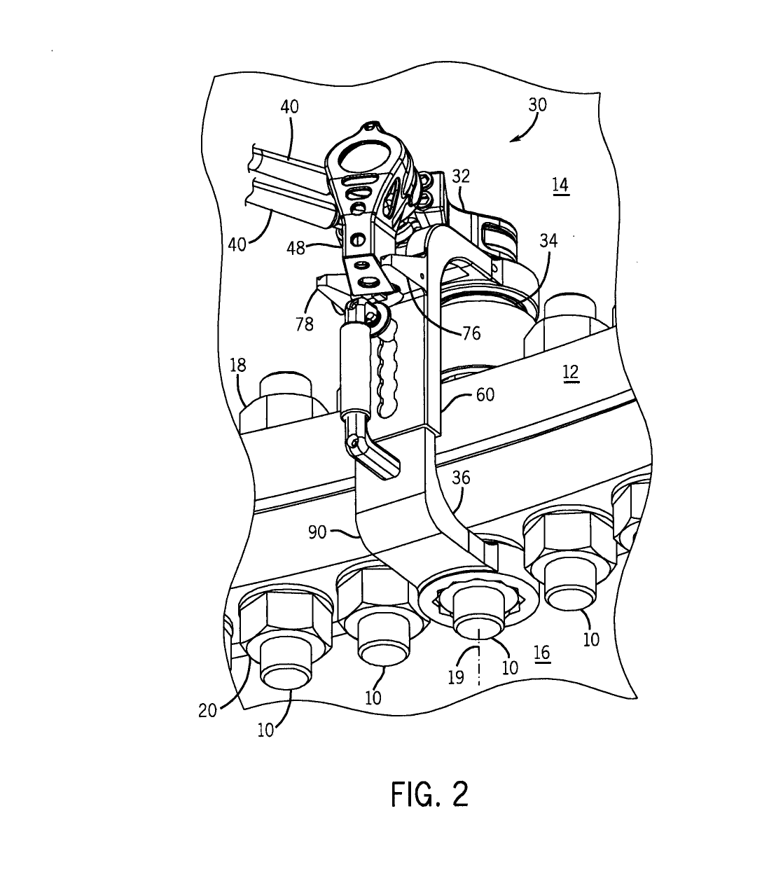

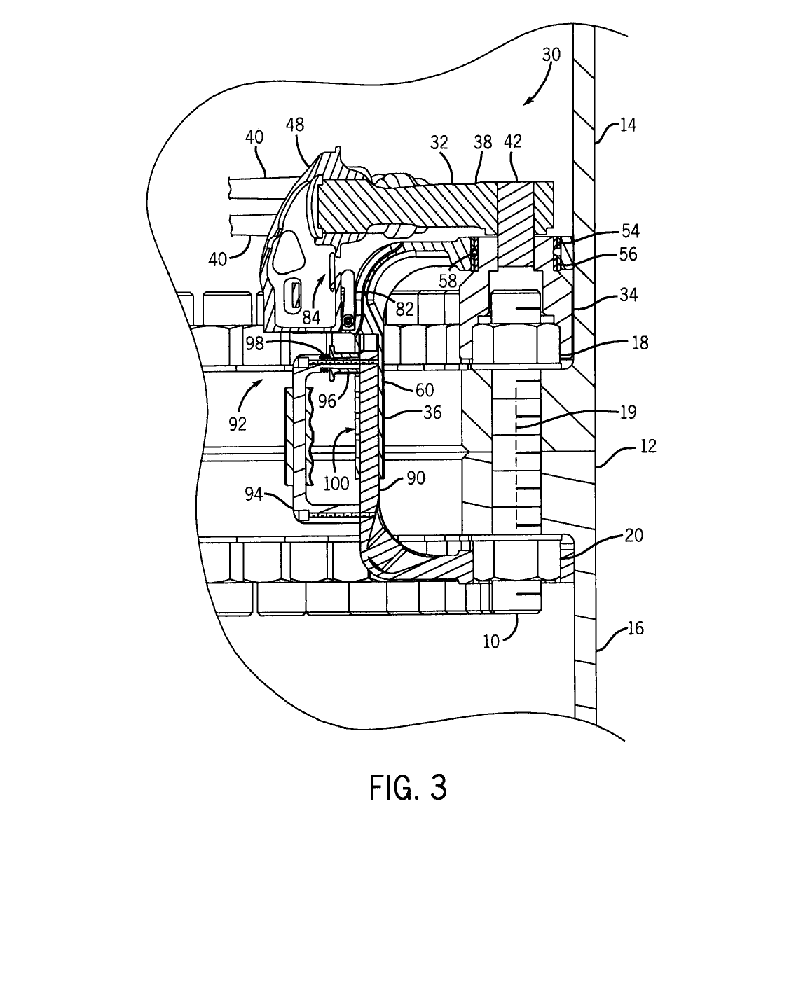

Referring now to FIGS. 1-3, a fastener wrenching apparatus 30 according to the present invention is operable to torque fasteners 10 that extend through openings of a joint 12 formed at an interface between a first component 14 and a second component 16 (e.g., openings in a flange formed at an interface between separate sections of a pipe). The fastener wrenching apparatus 30 generally includes a torque wrench 32 that drives a socket 34, and the socket 34 rotates a proximal end 18 of one of the fasteners 10 (FIG. 3) about the longitudinal axis 19 of the fastener 10. The fastener wrenching apparatus 30 further includes a reaction support 36 that engages a distal end 20 of the fastener 10 (FIG. 3) to react against the torque applied to the proximal end 18 of the fastener 10. As such, the fastener wrenching apparatus 30 does not need to abut an adjacent component (e.g., another fastener 10 or the flange 12) to ensure the wrenching apparatus 30 rotates the fastener 10 instead of itself. Furthermore, the apparatus 30 has a form-closed shape that, among other features, holds the device 30 in proper engagement with the fastener 10 and affixes the device 30 to the flange 12 during operation. As such, the wrenching apparatus 30 has a “hands-off” structure that permits an operator to step back and remotely operate the device 30. These components and advantages of the wrenching apparatus 30 are described in further detail in the following paragraphs.

Referring now to FIGS. 1-4, the torque wrench 32 may be one of many commercially available torque wrenches, such as an RSL Series hydraulic wrench manufactured by Hydratight Limited of Walsall, United Kingdom. Other hydraulic wrenches or even other types of torquing devices, such as pneumatic wrenches, electric wrenches, manual wrenches, torque multipliers, and the like, may also be used without departing from the scope of the invention. Several embodiments that include other types of torque wrenches are described in further detail below.

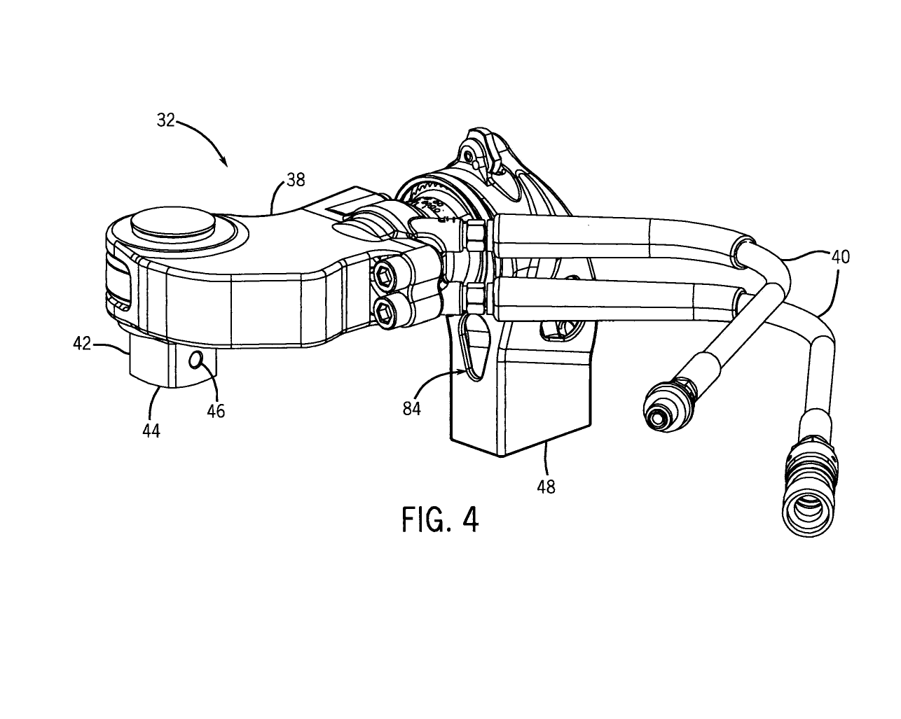

In the embodiment shown in the figures, the torque wrench 32 includes a housing 38 that supports hydraulic conduits 40 for connecting the torque wrench 32 to a hydraulic pump (not shown). Delivery of a hydraulic fluid from the pump to a hydraulic actuator (not shown) within the torque wrench housing 38 rotates an output drive 42 supported by the housing 38. The output 42 may have a square drive lug 44 (FIG. 4) for connecting to a driven component, although lugs having other shapes may alternatively be used. As another alternative, the output 42 may have an opening for accommodating and thereby engaging a driven component instead of a drive lug. In either case, the output 42 may include half of a connection mechanism 46 (e.g., a ball and detent mechanism, a pin and slot interface, or the like) to secure the torque wrench 32 to a driven component.

In order to react against the torque applied by the output 42, the torque wrench 32 also includes a reaction arm 48 supported by the housing 38. As shown in the figures, the reaction arm 48 may connect to the housing 38 at a side opposite the output 42 and may have a hollow structure that extends below the housing 38.

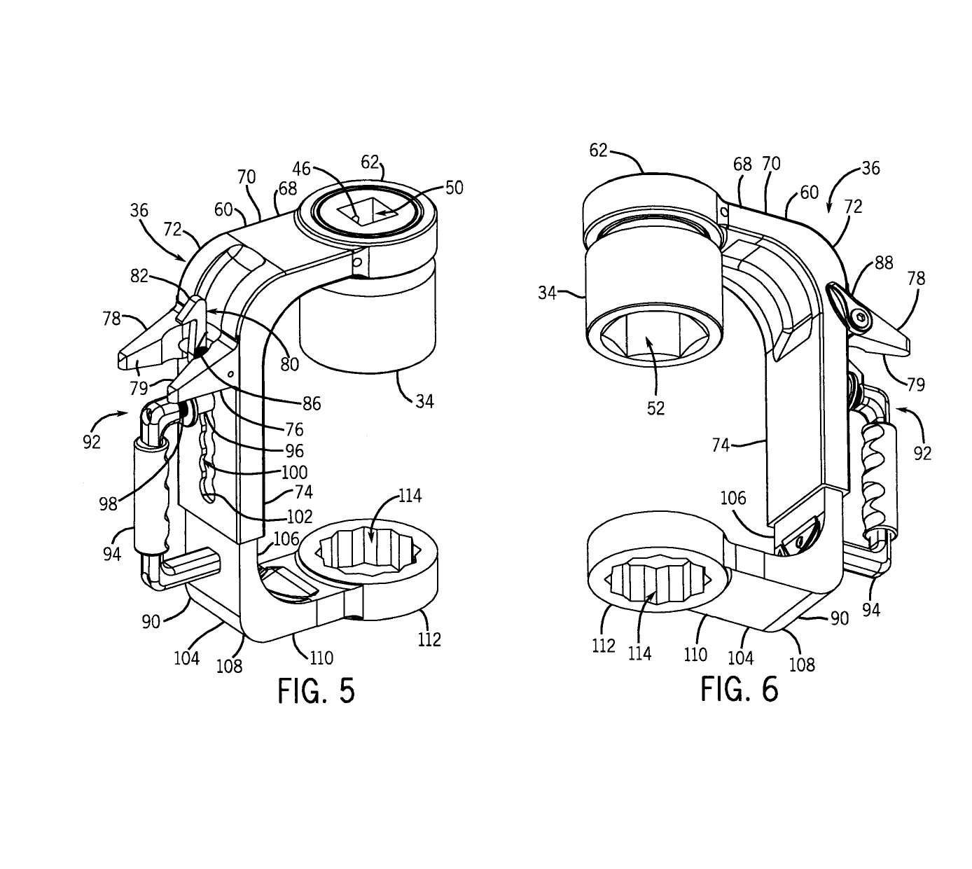

Referring now to FIGS. 5-8, the torque wrench 32 engages and rotates the socket 34. The socket 34 may be one of many commercially available sockets that are commonly associated with torque wrenches. That is, the socket 34 may include a square drive opening 50 to accommodate the square drive lug 44 of the output drive 42, although other shapes may alternatively be used. As another alternative, the socket 34 may have a lug for connecting to the output 42 if the output 42 includes an opening instead of a drive lug. In any case, the opening 50 or lug of the socket 34 may include half of the mechanism 46 (e.g., the ball and detent mechanism, the pin and slot interface, or the like) to secure the socket 34 to the torque wrench 32.

The socket 34 also includes a fastener opening 52 (FIG. 6) opposite the drive opening 50 that receives the proximal end 18 (e.g., a first nut connected to a threaded shaft) of the fastener 10. The drive opening 50 preferably has the same shape as the proximal end 18 of the fastener 10 to permit the socket 34 to engage the proximal end 18. For example and as shown most clearly in FIG. 6, the drive opening 50 may have a hexagonal shape if the proximal end 18 is a hexagonal nut. If a fastener 10 having a proximal end 18 with a different shape is to be wrenched, the socket 34 may be disconnected from the device 30 and interchanged with another socket having a different drive opening shape.

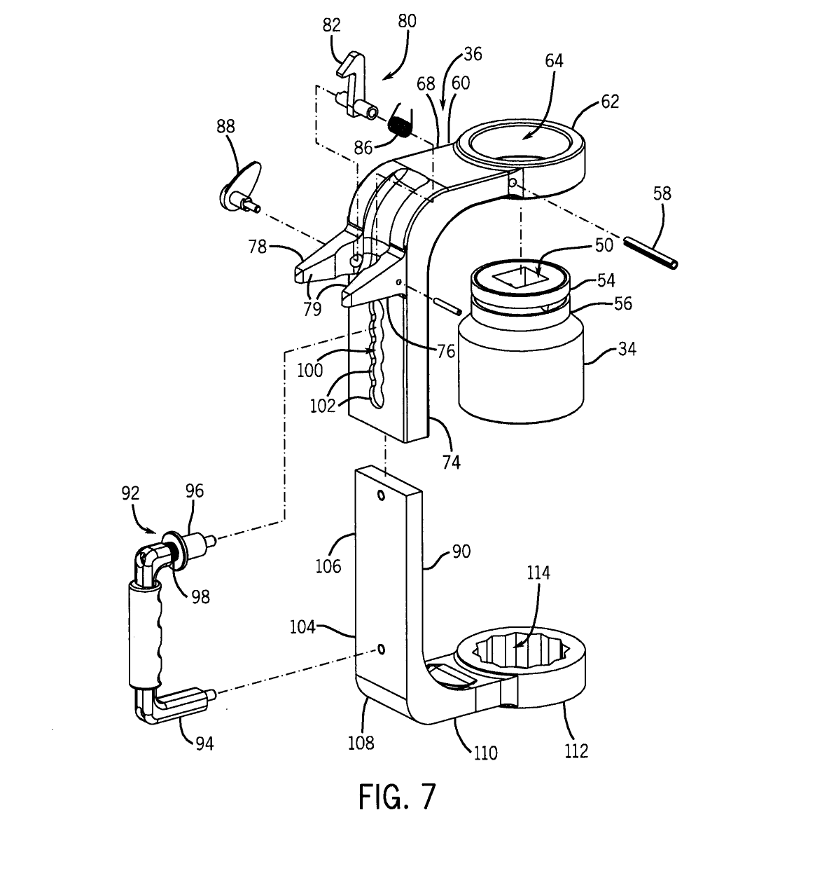

In addition to the openings 50 and 52, the socket 34 also preferably includes two bearings 54 and 56 that rotatably mount the socket 34 to the reaction support 36. As shown most clearly in FIG. 7, the bearings 54 and 56 may be spaced apart to define a space that receives a release pin 58. When in place, the release pin 58 permits rotation of the socket 34 but prevents the socket 34 from disconnecting from the reaction support 36. Conversely, when the release pin 58 is removed, the socket 34 may be disconnected from the device 30 and interchanged with other sockets as described above.

Still referring to FIGS. 5-8 and as briefly described above, the reaction support 36 mounts the torque wrench 32 and the socket 34 and reacts against the torque applied to the fastener 10. Furthermore, the reaction support 36 is structured in a U-shape such that it does not need to abut an adjacent component to react against the torque applied to the fastener 10. The structure and specific components of the reaction support 36 are described in further detail in the following paragraphs.

The reaction support 36 includes an upper support 60 proximate the torque wrench 32. In general, the upper support 60 preferably comprises a relatively high strength material, such as high-strength steel, and may be formed using processes such as forging and machining or casting and machining. Of course, other appropriate materials or manufacturing processes known to those skilled in art may also be used without departing from the scope of the invention.

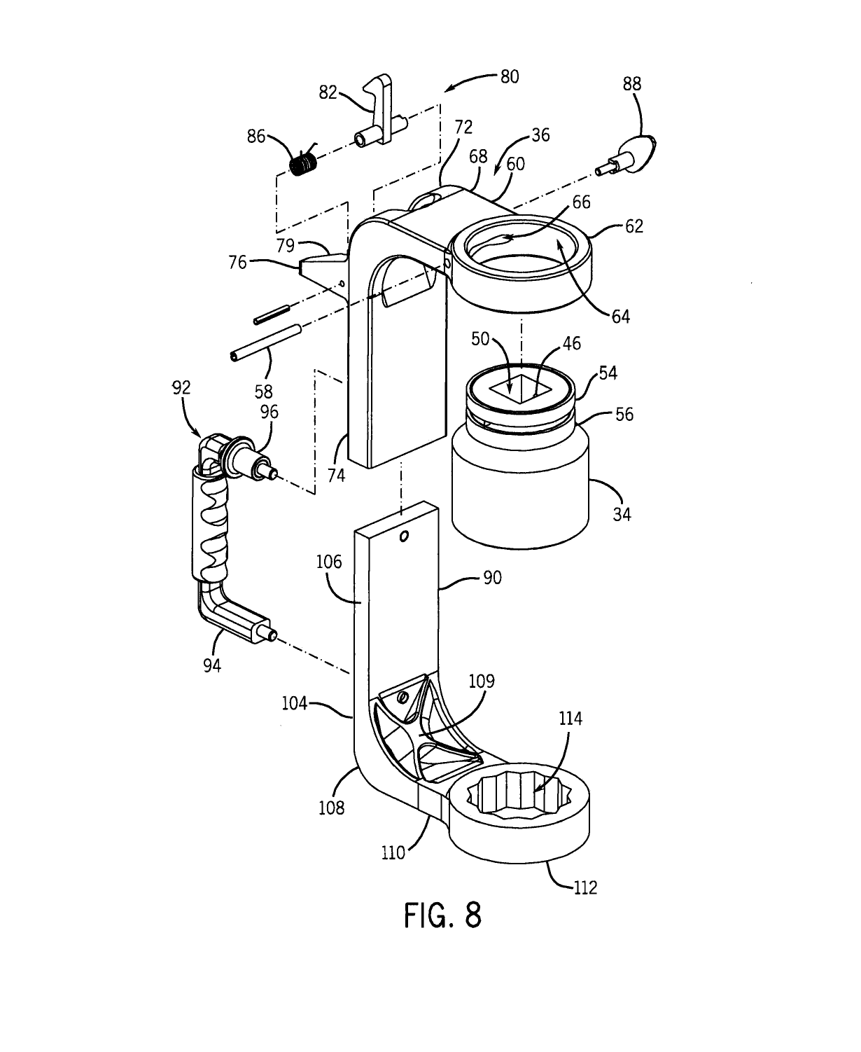

The upper support 60 includes a generally annular-shaped head 62 proximate the output 42 of the torque wrench 32. The head 62 includes a head opening 64 (FIGS. 7 and 8) that receives the bearings 54 and 56 of the socket 34. As such, the head 62 rotatably mounts the socket 34. In addition, the head 62 includes a release pin passageway 66 (FIG. 8) that receives the release pin 58 described above. The release pin 58 extends from the pin passageway 66 into the head opening 64 and thereby translatably locks the socket 34 relative to the head 62.

The head 62 connects to a neck 68 that is spaced apart from the longitudinal axis 19 of the fastener 10. The neck 68 also includes a generally inverted L-shape to avoid contact with the flange 12 and the fasteners 10. An upper section 70 of this generally inverted L-shape is disposed in the same longitudinal plane as the head 62 and extends away from the head 62. The upper section 70 connects to a corner 72 that may be thicker at the sides than the upper section 70 or have reinforcing ribs (not shown). Such features reduce the stress concentration factor at the corner 72. The corner 72 connects to a lower section 74 of the neck 68 that extends in the same direction as the longitudinal axis 19 of the fastener 10 and further defines the generally inverted L-shape of the neck 68. The lower section 74 of the neck 68 includes several advantageous components that are described in further detail in the following paragraphs.

The lower section 74 of the neck 68 supports two reaction fingers 76 and 78 that extend away from the lower section 74 opposite the upper section 70. The reaction fingers 76 and 78 define an inner reaction surface 79 that engages the reaction arm 48 of the torque wrench 32 during operation to react against the torque applied to the fastener 10. As such, contact between the reaction surface 79 and the reaction surface of the reaction arm 48 ensures the housing 38 of the torque wrench 32 remains stationary and the output 42 rotates during operation and not vice versa.

The reaction fingers 76 and 78 are preferably generally identical, although oriented in mirrored relationship relative to each other, for several reasons. First, the reaction arm 48 contacts and applies a reaction force to one of the reaction fingers 76 when the torque wrench 32 applies a torque to the fastener 10. However, when the torque wrench's hydraulic actuator retracts as described above, the reaction arm 48 contacts and applies a reaction force to the other reaction finger 78. Second, the generally identical and mirrored shape of the reaction fingers 76 and 78 permits the reaction support 36 to be used with both right hand threaded fasteners and left hand threaded fasteners. Third, the generally identical and mirrored shape of the reaction fingers 76 and 78 permits the reaction support 36 to apply torque to fasteners during both makeup and break down of a structure.

From the figures, it should be appreciated that contact between the reaction arm 48 and the reaction surface 79 applies a horizontal bending moment to the reaction support 36. To reduce this bending moment, the reaction surface 79 is preferably disposed at the midpoint of the flange in a vertical direction or, as shown in the figures, at least disposed below the upper section 70 of the neck 68.

In addition to providing a reaction surface 79 for the reaction arm 48, the reaction fingers 76 and 78 support a lock mechanism 80 that engages the torque wrench 32 to prevent it from unintentionally detaching from the reaction support 36. The lock mechanism 80 may comprise various components. For example and as shown in the figures, the lock mechanism 80 may include a pivotable latch 82 that extends into a latch opening 84 (FIGS. 3 and 4) to thereby engage the reaction arm 48. A torsion spring 86 biases the latch 82 to engage the reaction arm 48, although the latch 82 may be disengaged by pivoting a release handle 88 connected to the latch 82. In other embodiments, the lock mechanism 80 may include other common components, such as releasable pins or straps connecting the reaction support 36 and the reaction arm 48.

The lower section 74 of the neck 68 is at least partially hollow to translatably receive a lower support 90 of the reaction support 36. In other embodiments, the lower support 90 may be at least partially hollow to translatably receive the lower section 74 of the neck 68, or the components could translatably connect using other means. For example, the lower section 74 of the neck 68 could include an external track on which the lower support 90 moves. In any case, this translatable connection permits the overall height of the reaction support 36 to be varied to accommodate flanges and fasteners of various heights and configurations.

The lower support 90 mounts a height adjustment lock mechanism 92 that prevents the lower support 90 and the upper support 60 from translating relative to one another during operation. This height adjustment lock mechanism 92 may comprise various components. For example and as shown in the figures, the height adjustment lock mechanism 92 may include a handle 94 connected to the lower support 90. The handle 94 supports a spool 96 that is biased by a spring 98 towards a slot 100 in the lower section 74 of the neck 68. The slot 100 includes a plurality of surfaces 102 that at least partially match the shape of the spool 96 (e.g., the surfaces 102 are semi-circular). As such, contact between one of the surfaces 102 and the spool 96 locks the upper support 60 relative to the lower support 90 when the spool 96 enters the slot 100. Conversely, an operator may move the spool 96 out of the slot 100 to permit the upper support 60 and the lower support 90 to move relative to one another. The spool 96 may then be engaged with a different one of the surfaces 102 to lock the reaction support 36 at a different overall height. In other embodiments, the height adjustment lock mechanism 92 may take other forms, such as a releasable brake mechanism, a releasable ratchet mechanism, combinations thereof, or the like.

The structure of the lower support 90 is generally similar to that of the upper support 60. That is, in general, the lower support 90 preferably comprises a relatively high strength material, such as high-strength steel, and may be formed using processes such as forging and machining or casting and machining. Of course, other appropriate materials or manufacturing processes known to those skilled in art may also be used without departing from the scope of the invention.

The lower support 90 includes a leg 104 that is spaced apart from the longitudinal axis 19 of the fastener 10. The leg 104 also has a general L-shape to avoid contact with the flange 12 and the fasteners 10. An upper section 106 of this general L-shape extends in the same direction as the longitudinal axis 19 of the fastener 10. The upper section 106 also translatably engages the upper support 60 as described above. The upper section 106 connects to a corner 108 that may be thicker at the sides than the upper section 106 or have reinforcing ribs 109 (FIG. 8). Such features reduce the stress concentration factor at the corner 108. The corner 108 connects to a lower section 110 of the leg 104 that extends generally perpendicularly to the longitudinal axis 19 of the fastener 10.

The lower section 110 of the leg 104 connects to a generally annular-shaped foot 112 extending in the same longitudinal plane as the lower section 110. The foot 112 includes a foot opening 114 that receives the distal end 20 (e.g., a second nut connected to the threaded shaft) of the fastener 10. The foot opening 114 preferably has at least the same shape as the distal end 20 of the fastener 10. For example, the foot opening 114 may have a hexagonal shape or a double-hexagonal shape (i.e., two overlapping hexagons, a “12 point hex”) if the distal end 20 is a hexagonal nut. If a fastener 10 having a distal end 20 with a different shape is to be wrenched, the lower support 90 may be translated and disconnected from the upper support 60 and interchanged with another lower support having a different foot opening shape. In any case, the foot opening 114 permits the foot 112 to be rotatably fixable to the distal end 20 of the fastener 10.

A process for using the fastener wrenching apparatus 30 to torque a fastener 10 is preferably as follows. First, the fastener 10 is positioned in the opening of the flange 12 such that the proximal end 18 of the fastener 10 (e.g., the first nut) is disposed on a proximal side of the flange 12 and a distal end 20 of the fastener 10 (e.g., the second nut) is disposed on a distal side of the flange 12. Next, the height adjustment lock mechanism 92 of the fastener wrenching apparatus 30 is disengaged to permit the socket 34 and the foot 112 to move apart to a distance greater than the height of the fastener 10 (i.e., to permit the reaction support 36 to fit over the fastener 10). The socket 34 is then positioned over and thereby rotatably fixedly engaged with the proximal end 18 of the fastener 10. The foot 112 is also moved closer to the socket 34 and thereby rotatably fixedly engaged with the distal end 20 of the fastener 10. Of course, the previous two steps may be performed in the opposite order. In any case, the height adjustment lock mechanism 92 is then permitted to re-engage and thereby translatably lock the socket 34 relative to the foot 112. Next, the torque wrench 32 is energized and the socket 34 rotates the proximal end 18 of the fastener 10 relative to the foot 112 and the distal end 20 of the fastener 10 to thereby apply a torque to the fastener 10.

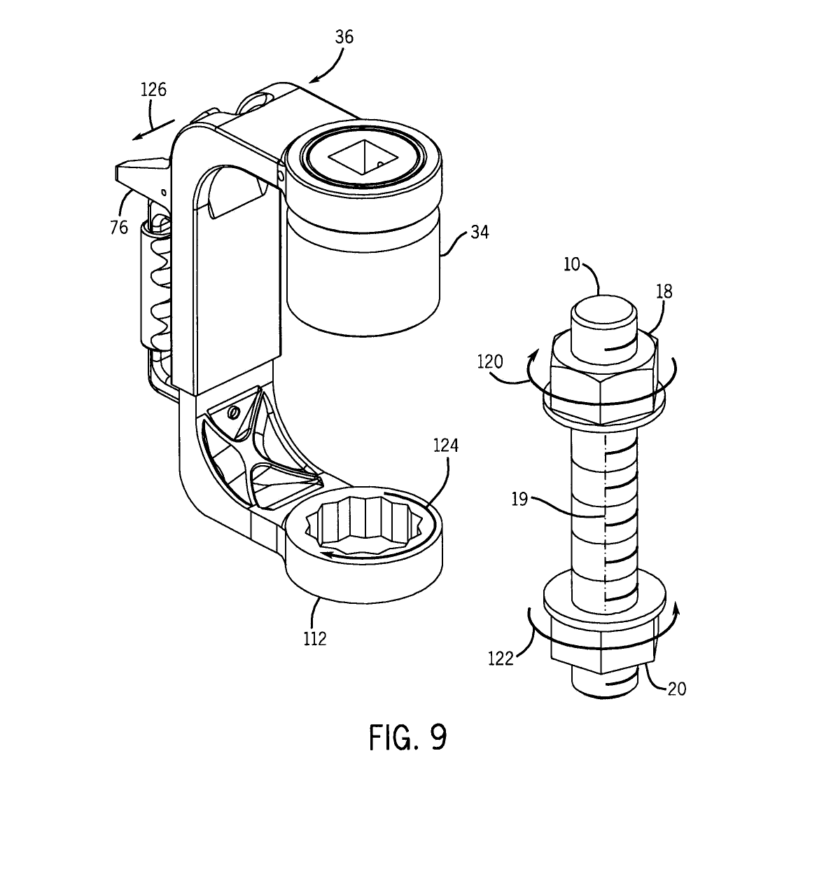

During operation, the socket 34 applies a clockwise torque 120 (as viewed from above, FIG. 9) to the proximal end 18 of the fastener 10 (if the fastener 10 is a right hand threaded fastener). This torque 120 tends to rotate both the proximal end 18 and the distal end 20 of the fastener 10 in a clockwise direction, although the distal end 20 is rotatably fixedly connected to the foot 112 of the reaction support 36. As such, the foot 112 applies a counter-clockwise torque 122 to the distal end 20 of the fastener 10, and the distal end 20 applies a clockwise torque 124 to the foot 112. The clockwise rotation of the socket 34 also causes the torque wrench reaction arm 48 to contact and apply a force 126 to the reaction finger 76 that provides a counter-clockwise torque about the longitudinal axis 19 of the fastener 10. This torque balances the torque 124 applied by the distal end 20 to the foot 112 and, as such, the reaction support 36 generally does not rotate about the longitudinal axis 19 of the fastener 10 during operation.

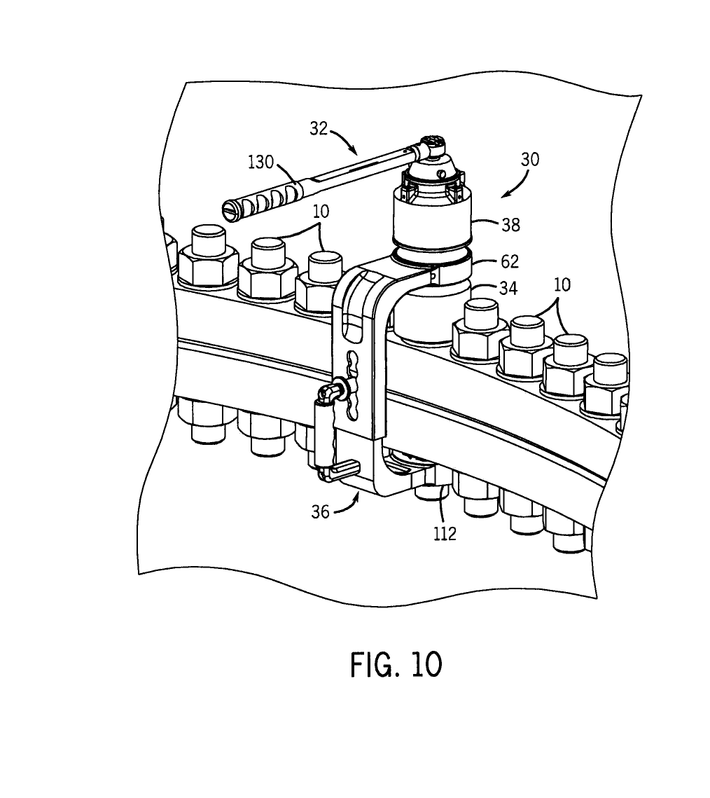

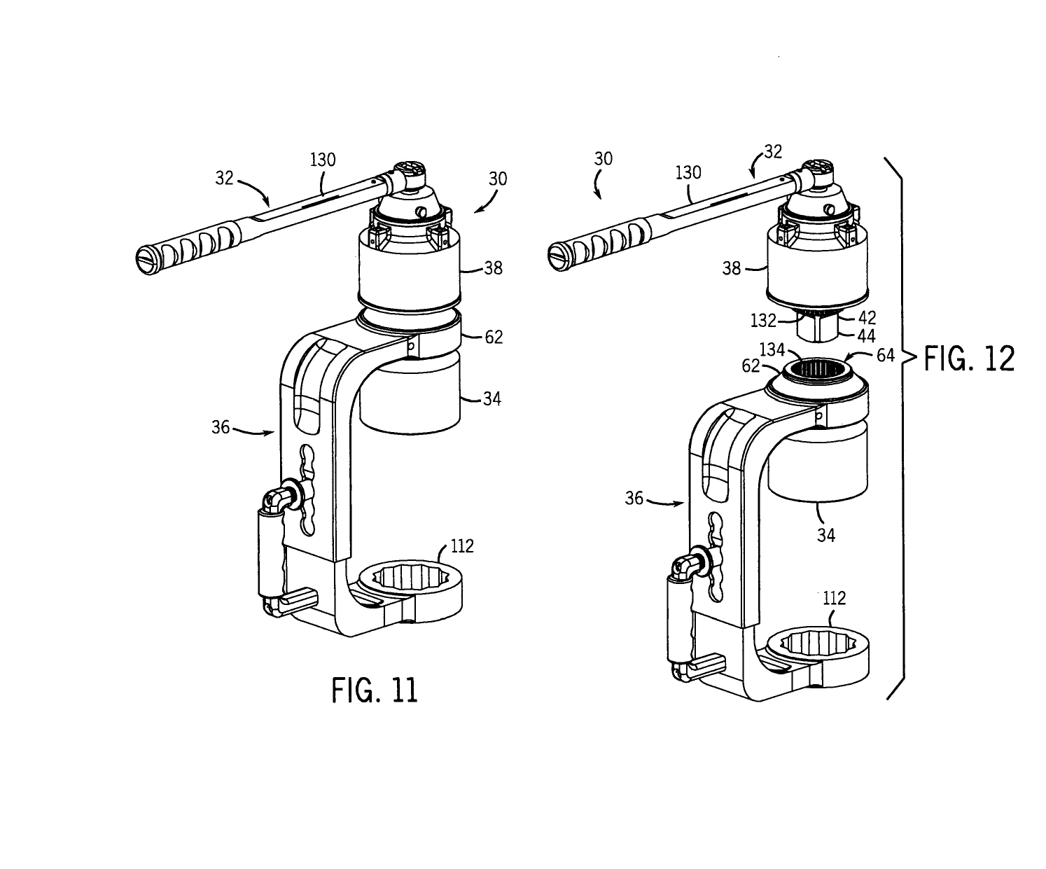

Turning now to FIGS. 10-18, the apparatus 30 may alternatively include other structures instead of the fingers 76 to ensure the housing 38 of the torque wrench 32 remains stationary and the output 42 rotates during operation. Such structures are briefly described below.

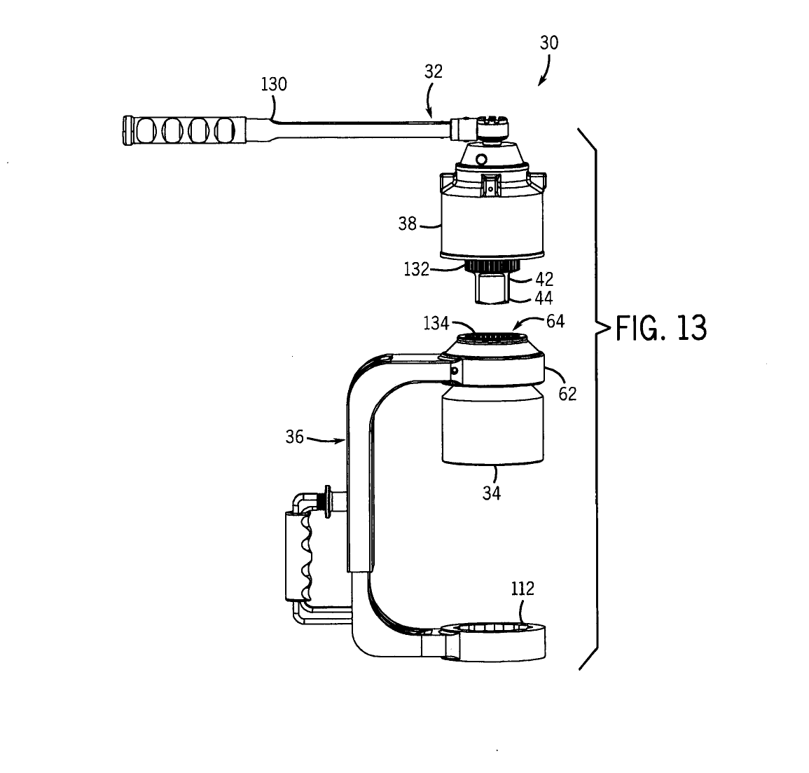

Referring first to FIGS. 10-13, a second embodiment of the apparatus 30 is generally similar to that described in connection with FIGS. 1-9. However, the torque wrench 32 is a manual torque wrench having a handle 130 that is pivotable by a user relative to a housing 38 to apply a torque. The torque is applied via an output 42 that may have a square drive lug 44 (FIG. 12), although lugs having other shapes may alternatively be used. The square drive lug 44 is driven by the handle 130 through a gear reduction unit, for example a planetary gear drive transmission, inside the housing 38. With such a transmission, the housing forms part of the transmission, and must be held rotationally stationary for the torque applied through the handle 130 to be amplified and applied to the fastener. In any case, the output 42 drives a socket 34 as described above. To ensure the housing 38 of the torque wrench 32 remains stationary relative to the reaction support 36 and the flange during operation, the housing 38 includes an outer spline reaction surface 132 (FIGS. 12 and 13) that extends about the output 42 and engages an inner spline reaction surface 134 defined within the opening 64 of the head 62.

Such a spline configuration may alternatively be used with other types of torque wrenches, such as the hydraulic torque wrench described in connection with FIGS. 1-9, an electrically driven torque wrench or torque multiplier, which may have a cord or be battery powered, an air powered torque wrench or torque multiplier, or the like.

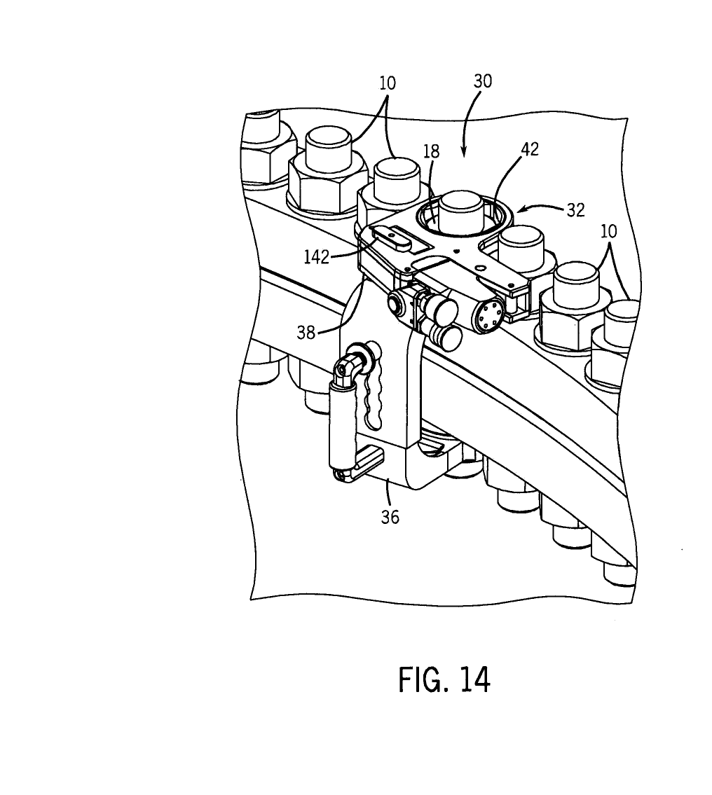

Referring now to FIGS. 14-18, a third embodiment of the apparatus 30 is generally similar to the previous embodiments. However, the torque wrench 32 is a hydraulic torque wrench having a rotatable output 42 that also serves as a socket or box end wrench for receiving the proximal end 18 of the fastener 10. In the embodiment shown in FIGS. 14-18, the output 42 includes a hexagonal opening 52 to receive the hexagonal nut 18, although the opening 52 may be any shape provided it is capable of rotatably fixedly receiving the nut 18.

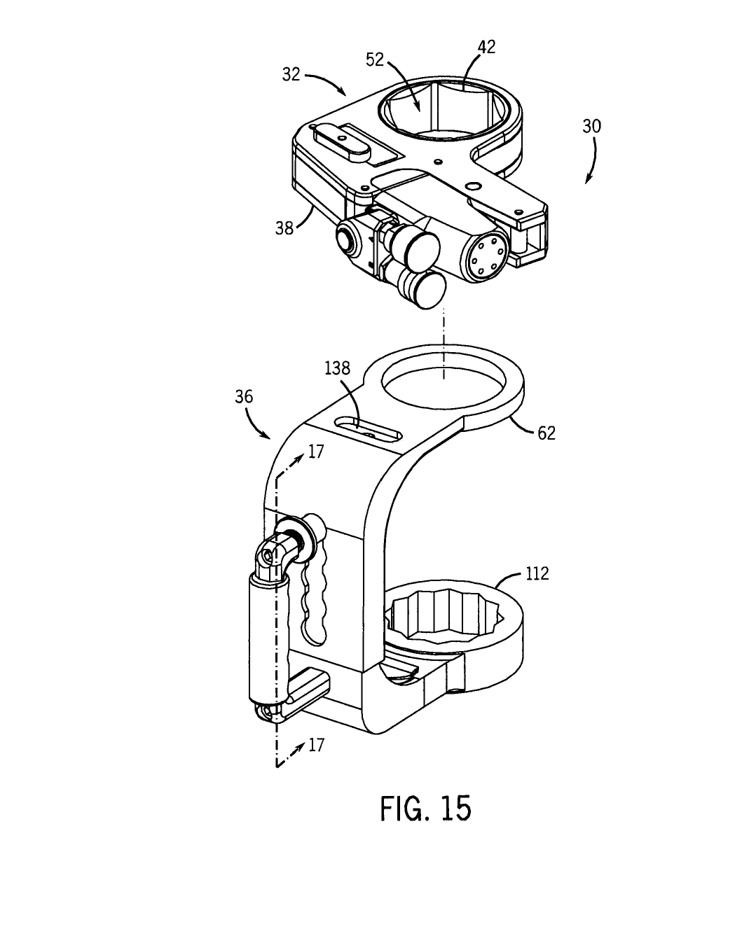

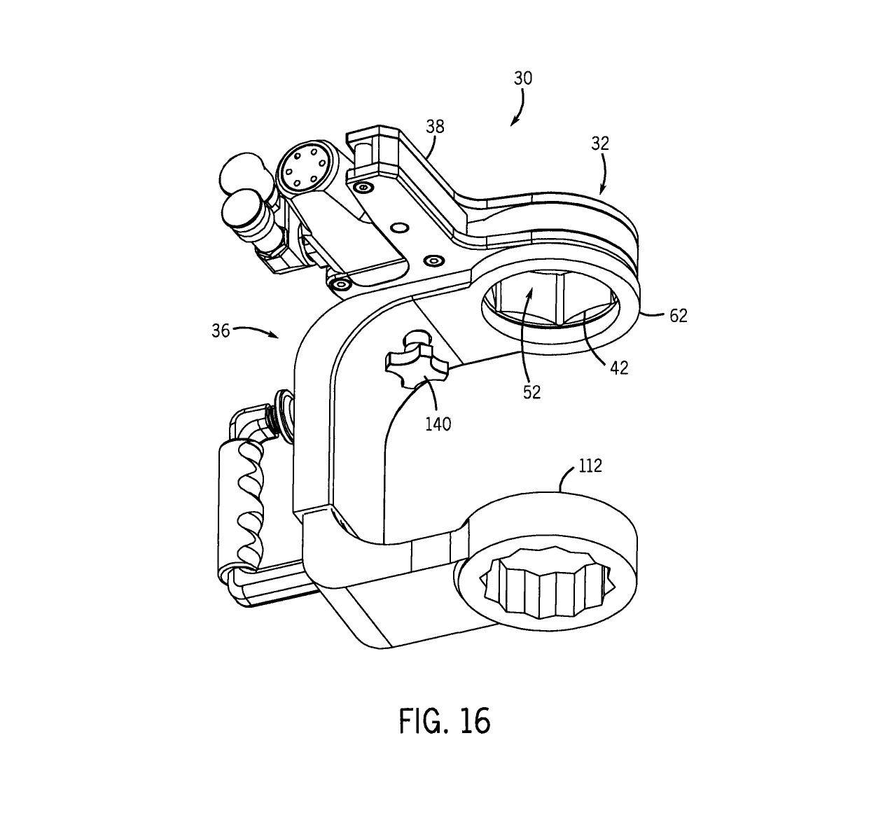

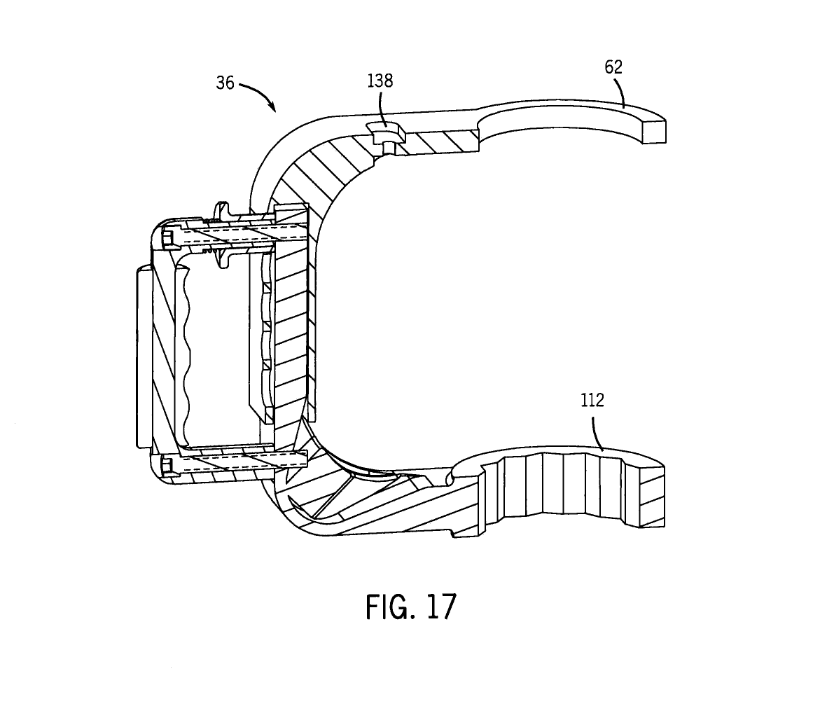

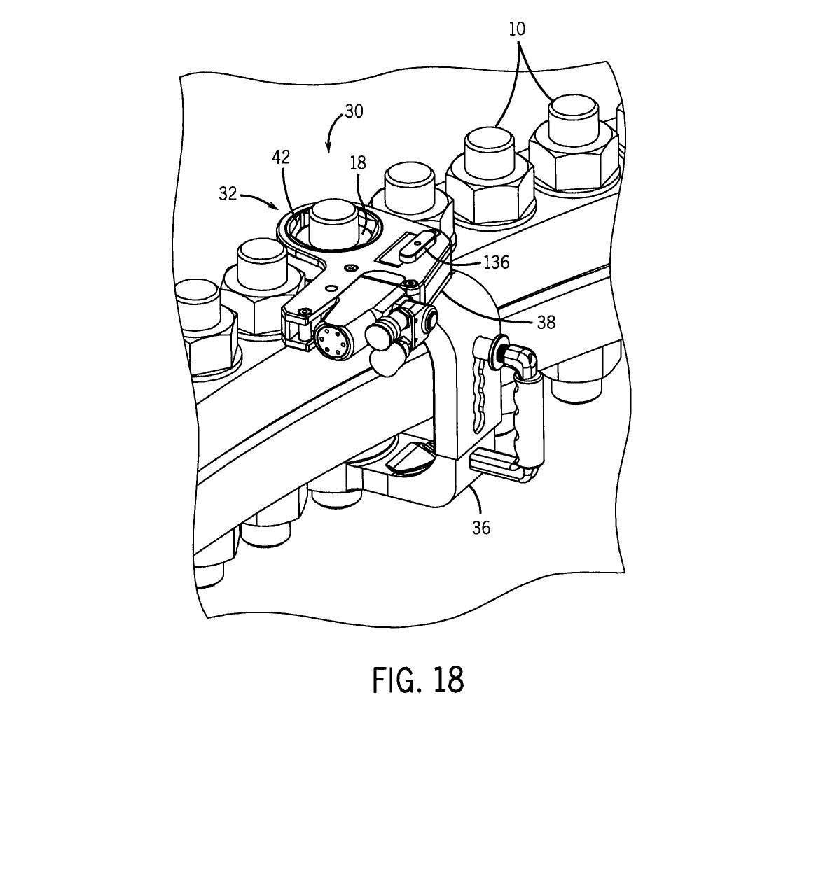

To ensure the housing 38 of the torque wrench 32 remains stationary relative to the reaction support 36 and the flange during operation, the housing 38 includes an oval-shaped projection 136 (FIG. 18) that defines a reaction surface. The projection is received in an oval-shaped recess 138 (FIGS. 15 and 17) in the reaction support 36 that also defines a reaction surface. A fastener 140 (FIG. 16) extends through the reaction support 36, the recess 138, and engages the projection 136 to secure the torque wrench 32 to the reaction support 36.

In the configuration shown in FIGS. 14-17, the torque wrench 32 is operable to tighten the fastener 10. However and as shown in FIG. 18, the torque wrench 32 may be inverted and connected to the reaction support 36 such that it is operable to loosen the fastener 10. For this reason, the housing 38 of the torque wrench 32 further includes a second oval-shaped projection 142 (FIG. 14) opposite the first projection 136. In the configuration shown in FIG. 18, the second projection 142 is received in the recess 138 and the fastener 140 engages the second projection 142 to secure the torque wrench 32 to the reaction support 36.

From the above description, it should be apparent that the wrenching apparatus 30 of the present invention, unlike previous torque wrench designs, can be operated remotely and without significant operator intervention. This is due, in part, to the fact that the reaction support 36 has a form-closed shape that, among other features, holds the device 30 in proper engagement with the fastener 10 and affixes the device 30 to the flange 12 during operation. Furthermore, the torque wrench 32 is affixed to the reaction support 36 and is also thereby affixed to the flange 12 during operation. These features, among others, provide the wrenching apparatus 30 with a “hands-off” structure that permits an operator to step back and remotely operate the device 30.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

We claim:

1. A fastener wrenching apparatus for applying torque to a threaded fastener having a proximal end and a distal end, comprising:
a reaction support having a head and a foot opposite the head, the foot being configured to engage the distal end of the fastener such that the distal end of the fastener and the foot are engaged so as not to rotate relative to each other;
a torquing device supported by the reaction support, the torquing device including a housing and an output rotatably supported by the housing, the output being disposed proximate the head of the reaction support and being configured to connect to the proximal end of the fastener and rotate the proximal end of the fastener relative to the reaction support and the distal end of the fastener to apply torque to the fastener; and
a mechanism releasably restraining the torquing device relative to the reaction support.

2. The fastener wrenching apparatus of claim 1, wherein the reaction support includes an upper support having the head and a lower support having the foot, and the upper support and the lower support are translatably connected to permit a distance between the head and the foot to be adjusted.

3. The fastener wrenching apparatus of claim 1, wherein the head and the foot are disposed along an axis about which the torquing device rotates the proximal end of the fastener, and wherein the reaction support further includes:
an upper support having a neck spaced apart from the axis and supporting the head; and
a lower support having a leg spaced apart from the axis and supporting the foot, the leg being connected to the neck such that the reaction support is U-shaped.

4. The fastener wrenching apparatus of claim 1, wherein the reaction support includes a reaction surface, the torquing device further includes a reaction arm supported by the housing, and the reaction arm abuts the reaction surface when the output rotates relative to the housing to prevent the torque from rotating the housing relative to the reaction support.

5. The fastener wrenching apparatus of claim 4, wherein the reaction support includes an upper support having the head, and the mechanism directly connects the upper support and the reaction arm.

6. The fastener wrenching apparatus of claim 1, wherein the output includes a hexagonal opening configured to receive the proximal end of the fastener.

7. The fastener wrenching apparatus of claim 4, wherein the reaction surface is disposed between the head and the foot.

8. The fastener wrenching apparatus of claim 1, further comprising a socket rotatably supported at the head of the reaction support, the socket having a fastener opening configured to receive the proximal end of the fastener, and the socket being driven by the output to rotate the proximal end of the fastener relative to the reaction support and the distal end of the fastener to apply the torque to the fastener.

9. The fastener wrenching apparatus of claim 8, wherein the fastener opening has a hexagonal shape.

10. The fastener wrenching apparatus of claim 1, wherein the foot includes a foot opening configured to accommodate and thereby engage the distal end of the fastener such that the distal end of the fastener is rotatably fixed to the foot.

11. The fastener wrenching apparatus of claim 10, wherein the foot opening has a double-hexagonal shape.

12. A fastener wrenching apparatus for applying a torque to a fastener having a proximal end and a distal end, comprising:
a reaction support including:
a lower support having a foot, the foot defining a foot opening configured to accommodate and thereby engage the distal end of the fastener such that the distal end of the fastener is rotatably fixed to the lower support;
an upper support translatably supported by the lower support, the upper support having a reaction surface and a head;
a torquing device supported by the reaction support proximate the head and including:
a housing;
an output rotatably supported by the housing and configured to connect to the proximal end of the fastener, the output rotating the proximal end of the fastener relative to the reaction support and the distal end to apply the torque to the fastener; and
a reaction surface defined by the housing, the reaction surface of the torquing device abutting the reaction surface of the reaction support when the output rotates relative to the housing to react against the torque applied to the fastener.

13. The fastener wrenching apparatus of claim 12, wherein the reaction support further includes a height adjustment lock mechanism that is selectively releasable to permit the lower support and the upper support to translate relative to one another.

14. The fastener wrenching apparatus of claim 13, wherein the height adjustment lock mechanism is biased toward a position in which it holds the lower support fixed relative to the upper support.

15. The fastener wrenching apparatus of claim 12, wherein the reaction surface of the torquing device is a spline surface and the reaction surface of the reaction support is a spline surface.

16. A method of applying a torque to a fastener using a fastener wrenching apparatus, comprising the steps of:
positioning the fastener in an opening of a joint formed at an interface of two separate components such that a proximal end of the fastener is disposed on a proximal side of the joint and a distal end of the fastener is disposed on a distal side opposite the proximal side;
connecting the fastener wrenching apparatus to the fastener such that a reaction support of the fastener wrenching apparatus rotatably fixedly engages the distal end of the fastener, and such that a socket rotatably mounted to the reaction support rotatably fixedly engages the proximal end of the fastener; and
rotating the socket and the proximal end of the fastener relative to the distal end to thereby apply the torque to the fastener.

17. The method of claim 16, wherein the step of rotating the socket and the proximal end of the fastener relative to the distal end to thereby apply the torque to the fastener includes driving a torquing device in driving engagement with the socket.

18. The method of claim 17, wherein the step of rotating the socket and the proximal end of the fastener relative to the distal end to thereby apply the torque to the fastener includes engaging a reaction arm of the torquing device against a reaction surface of the reaction support to react against the torque applied to the fastener.

19. The method of claim 17, further comprising the step of locking the torquing device to the reaction support.

20. The method of claim 16, wherein the step of connecting the fastener wrenching apparatus to the fastener includes moving an upper support of the reaction support relative to a lower support of the reaction support such that the socket engages the proximal end of the fastener and a foot of the lower support engages the distal end of the fastener.
